(19) United States
(12) Patent Application Publication
(10) Pub. No.: US 2025/0278854 A1
(43) Pub. Date: Sep. 4, 2025

(54) INFORMATION PROCESSING APPARATUS, SELF-POSITION ESTIMATION METHOD, AND NON-TRANSITORY COMPUTER-READABLE MEDIUM

(71) Applicant: NEC Corporation, Minato-ku, Tokyo (JP)

(72) Inventor: Takahiro SHIROSHIMA, Tokyo (JP)

(73) Assignee: NEC Corporation, Minato-ku, Tokyo (JP)

(21) Appl. No.: 18/857,861

(22) PCT Filed: Jul. 5, 2022
(86) PCT No.: PCT/JP2022/026666

§ 371 Date: Oct. 18, 2024

(51) Int. Cl. G06T 7/73; G06V 10/44

(52) U.S. Cl. CPC G06T 7/73; G06V 10/44

(57) ABSTRACT

An information processing apparatus according to the present disclosure includes: a detection unit configured to detect a plurality of new feature points from a first image; a specification unit configured to specify, among the plurality of new feature points, a corresponding feature point corresponding to a known feature point associated with a three-dimensional position included in at least one management image used for generating an environment map; and an estimation unit configured to estimate a position and a posture of an imaging device that has captured the first image, by using the corresponding feature point, in which the detection unit changes the number of new feature points to be detected from a target image that is a target for estimating the position and the posture of the imaging device according to the number of corresponding feature points.

### TECHNICAL FIELD

The present disclosure relates to an information processing apparatus, a self-position estimation method, and a non-transitory computer-readable medium.

### BACKGROUND ART

In recent years, services based on the premise that robots move autonomously have become widespread. In order for a robot to autonomously move, it is necessary for the robot to recognize the surrounding environment and estimate its own position with high accuracy. Therefore, visual simultaneous localization and mapping (VSLAM) for simultaneously executing creation of a surrounding environment map from a video captured by the robot and estimation of a self-position with reference to the created environment map has been studied. In the general VSLAM, the same point shown in a plurality of videos is recognized as a feature point in a plurality of images (still images) constituting the videos, and positions of a camera where the images are captured are estimated from a difference in feature point between the images. Since a position of the camera in the robot is fixed, if the position of the camera can be estimated, the position of the robot can be estimated. In the estimation of the position of the camera by the VSLAM, the position of the camera is estimated by using a two-dimensional position obtained by estimating a three-dimensional position of the feature point included in the plurality of images and projecting the estimated three-dimensional position on the image, and a difference in position of the feature point included in the images. In such VSLAM, immediate processing is required, and thus, it is required to reduce a processing load.

Patent Literature 1 describes a configuration of an autonomous movement apparatus that acquires a correspondence between a feature point included in information of an image stored in a storage unit and a feature point extracted from a captured image and estimates a self-position. Furthermore, Patent Literature 1 describes that images to be stored in the storage unit are thinned out according to the number of corresponding feature points acquired at the time of estimation.

Patent Literature 2 describes a configuration of an information processing apparatus that extracts a feature point from an input image and detects a position and posture of an imaging device that captures the input image based on the extracted feature point. The information processing apparatus of Patent Literature 2 changes the number of feature points to be extracted from the input image based on a processing time required to detect the position and posture of the imaging device from the input image.

### CITATION LIST

### Patent Literature

Patent Literature 1: Japanese Unexamined Patent Application Publication No. 2020-57187
Patent Literature 2: Japanese Unexamined Patent Application Publication No. 2021-9557

### SUMMARY OF INVENTION

### Technical Problem

However, in the autonomous movement apparatus disclosed in Patent Literature 1, as the number of corresponding feature points acquired at the time of estimation is larger than a threshold, the number of images to be thinned out is increased, so that the number of images to be stored is reduced. In this case, there is a problem that accuracy of self-position estimation deteriorates as the number of images used for self-position estimation decreases. Furthermore, in the information processing apparatus disclosed in Patent Literature 2, as the processing load of a process different from a process of detecting the position and posture of the imaging device increases, the processing time required to detect the position and posture of the imaging device also increases. In this case, the number of feature points extracted from the input image by the information processing apparatus decreases, and thus, there is a problem that the accuracy of self-position estimation deteriorates.

In view of the above-described problems, an object of the present disclosure is to provide an information processing apparatus, a self-position estimation method, and a non-transitory computer-readable medium capable of preventing deterioration in accuracy of self-position estimation when reducing a processing load.

### Solution to Problem

An information processing apparatus according to a first aspect of the present disclosure includes: a detection unit configured to detect a plurality of new feature points from a first image; a specification unit configured to specify, among the plurality of new feature points, a corresponding feature point corresponding to a known feature point associated with a three-dimensional position included in at least one management image used for generating an environment map; and an estimation unit configured to estimate a position and a posture of an imaging device that has captured the first image, by using the corresponding feature point, in which the detection unit changes the number of new feature points to be detected from a target image that is a target for estimating the position and the posture of the imaging device according to the number of corresponding feature points.

A self-position estimation method according to a second aspect of the present disclosure includes: detecting a plurality of new feature points from a first image; specifying, among the plurality of new feature points, a corresponding feature point corresponding to a known feature point associated with a three-dimensional position included in at least one management image used for generating an environment map; estimating a position and a posture of an imaging device that has captured the first image, by using the corresponding feature point; and changing the number of new feature points to be detected from a target image that is a target for estimating the position and the posture of the imaging device according to the number of corresponding feature points.

A program according to a third aspect of the present disclosure causes a computer to execute: detecting a plurality of new feature points from a first image; specifying, among the plurality of new feature points, a corresponding feature point corresponding to a known feature point associated with a three-dimensional position included in at least one management image used for generating an environment map; estimating a position and a posture of an imaging device that has captured the first image, by using the corresponding feature point; and changing the number of new feature points to be detected from a target image that is a target for estimating the position and the posture of the imaging device according to the number of corresponding feature points.

### Advantageous Effects of Invention

According to the present disclosure, it is possible to provide the information processing apparatus, the self-position estimation method, and the non-transitory computer-readable medium capable of preventing deterioration in accuracy of self-position estimation when reducing a processing load.

### BRIEF DESCRIPTION OF DRAWINGS

FIG. 1 is a configuration diagram of an information processing apparatus according to a first example embodiment.

FIG. 2 is a diagram illustrating a flow of self-position estimation processing according to the first example embodiment.

FIG. 3 is a configuration diagram of an information processing apparatus according to a second example embodiment.

FIG. 4 is a diagram for describing feature point matching processing according to the second example embodiment.

FIG. 5 is a diagram for describing feature point classification processing according to the second example embodiment.

FIG. 6 is a diagram illustrating a flow of processing of updating a target number of feature points according to the second example embodiment.

FIG. 7 is a configuration diagram of the information processing apparatus according to each example embodiment.

### EXAMPLE EMBODIMENT

### First Example Embodiment

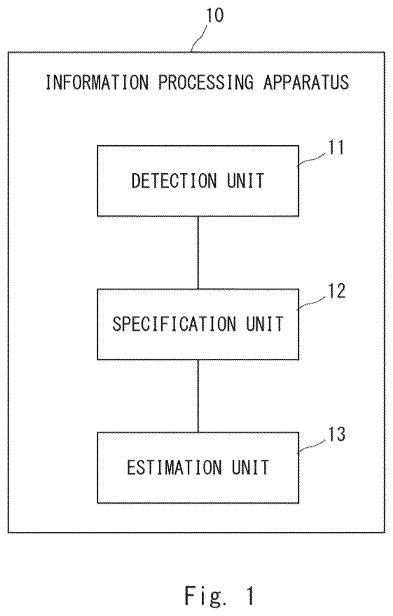

Example embodiments of the present disclosure will be described below with reference to the drawings. A configuration example of an information processing apparatus 10 according to a first example embodiment will be described with reference to FIG. 1. The information processing apparatus 10 may be a computer apparatus that operates when a processor executes a program stored in a memory. The information processing apparatus 10 may be, for example, a server apparatus.

The information processing apparatus 10 includes a detection unit 11, a specification unit 12, and an estimation unit 13. The detection unit 11, the specification unit 12, and the estimation unit 13 may be software or modules whose processing is carried out by causing the processor to execute the program stored in the memory. Alternatively, the detection unit 11, the specification unit 12, and the estimation unit 13 may be hardware such as a circuit or a chip. In FIG. 1, the detection unit 11, the specification unit 12, and the estimation unit 13 are included in one information processing apparatus 10, but the detection unit 11, the specification unit 12, and the estimation unit 13 may be arranged in different computer apparatuses. Alternatively, one of the detection unit 11, the specification unit 12, and the estimation unit 13 may be arranged in a different computer apparatus. Computers including the detection unit 11, the specification unit 12, and the estimation unit 13 may communicate with each other via a network.

The detection unit 11 detects a plurality of new feature points from a first image. The first image may be an image captured by an imaging device mounted on a mobile body such as a vehicle. The imaging device mounted on the mobile body may generate an image by imaging a traveling direction of the mobile body or the periphery of the mobile body during movement of the mobile body. The detection unit 11 may receive the image captured by the imaging device via the network. Alternatively, in a case where the imaging device is used integrally with the information processing apparatus 10, that is, in a case where the imaging device is included in the information processing apparatus 10 or the imaging device is connected to the information processing apparatus 10, the detection unit 11 may acquire the image without using the network. Alternatively, the first image may be an image received from another information processing apparatus or the like via the network.

The imaging device may be, for example, a camera or a device having a camera function. The device having the camera function may be, for example, a mobile terminal such as a smartphone. The image may be, for example, a still image. Alternatively, the image may be a frame image constituting a moving image. Furthermore, a plurality of images may be a data set or data record representing a plurality of still images, such as a plurality of frame images constituting a moving image. Alternatively, the plurality of images may be frame images extracted from a plurality of frame images constituting a moving image.

The mobile body may be, for example, a robot or a vehicle that moves autonomously. The autonomous movement may be an operation by a control apparatus mounted on the robot, the vehicle, or the like without direct control of the vehicle by a person.

The new feature point may be detected using, for example, scale-invariant feature transform (SIFT), speeded up robust features (SURF), oriented FAST and rotated BRIEF (ORB), accelerated-KAZE (AKAZE), or the like. The new feature point may be indicated using two-dimensional coordinates that are camera coordinates defined in the imaging device.

The specification unit 12 specifies, as a corresponding feature point, a new feature point corresponding to a known feature point included in at least one management image used for generating an environment map, the known feature point being associated with a three-dimensional position.

The environment map is three-dimensional information, and is a map indicating an environment around the imaging device by using the three-dimensional information. The three-dimensional information may be paraphrased as 3D information, three-dimensional coordinates, or the like. The environment map includes map information indicating the environment around the imaging device, and also includes information regarding a position and posture of the imaging device. The posture of the imaging device may be, for example, information regarding an inclination of the imaging device. The environment map is generated by specifying imaging positions where the plurality of images is captured and restoring three-dimensional positions of the feature points recorded on the images. That is, the environment map includes information regarding the three-dimensional positions or three-dimensional coordinates of the feature points in the image captured by the imaging device. For example, the environment map may be generated by executing structure from motion (SfM) using the plurality of images. The SfM calculates all feature points of a series of already acquired two-dimensional images (or frames), and estimates matching feature points from a plurality of temporally successive images. Further, the SfM accurately estimates a three-dimensional position or posture of a camera that has captured each frame based on a difference in position on a two-dimensional plane between the frames in which each feature point appears. The management image is an image used when executing the SfM. In addition, the environment map may be created by accumulating images with which estimation is performed using visual simultaneous localization and mapping (VSLAM) in the past. In this case, the management image is an image input to the VSLAM and used for estimation of the three-dimensional position.

The known feature point is a feature point included in the management image and indicated using two-dimensional coordinates. Furthermore, the three-dimensional position associated with the known feature point may be indicated using, for example, three-dimensional coordinates. The corresponding feature point may be, for example, a feature point having a feature that is the same as or similar to the known feature point. The corresponding feature point may be paraphrased as, for example, a feature point matching the known feature point. That is, it may also be said that the specification unit 12 specifies or extracts a new feature point matching the known feature point from among the plurality of new feature points.

The estimation unit 13 estimates the position and posture of the imaging device that has captured the first image, by using the corresponding feature point. For example, the estimation unit 13 may estimate the position and posture of the imaging device that has captured the first image by executing the VSLAM. Estimating the position and posture of the imaging device that has captured the first image may mean estimating the position and posture of the mobile body on which the imaging device is mounted.

Here, the detection unit 11 also estimates the position and posture of the imaging device that has captured each image from an image captured at a timing later than a timing at which the first image is captured. The image captured at the timing later than the timing at which the first image is captured is referred to as a target image that is a target for estimating the position and posture of the imaging device.

The detection unit 11 changes the number of new feature points to be detected from the target image according to the number of corresponding feature points used when estimating the position and posture of the imaging device that has captured the first image. For example, in a case where the number of corresponding feature points used when estimating the position and posture of the imaging device that has captured the first image (hereinafter, simply referred to as “the number of corresponding feature points”) is larger than a predetermined number, the number of new feature points to be detected from the target image may be reduced to a number smaller than the currently set number. In a case where the number of corresponding feature points is smaller than the predetermined number, the number of new feature points to be detected from the target image may be increased from the currently set number.

The predetermined number of corresponding feature points can be said to be a sufficient number of corresponding feature points for estimating the position and posture of the imaging device that has captured the target image. The sufficient number of corresponding feature points for estimating the position and posture of the imaging device that has captured the target image means the number of corresponding feature points that enables accurate estimation of the position and posture of the imaging device that has captured the target image. Therefore, in a case where the number of corresponding feature points is larger than the predetermined number of corresponding feature points, even when the number of new feature points to be detected from the target image is reduced, the specification unit 12 can specify the sufficient number of corresponding feature points for estimating the position and posture of the imaging device that has captured the target image. Furthermore, by reducing the number of new feature points to be detected from the target image, it is possible to reduce a processing load related to the specification of the corresponding feature points and a processing load related to the estimation of the position and posture of the imaging device using the corresponding feature points.

On the other hand, in a case where the number of corresponding feature points is smaller than the predetermined number of corresponding feature points, it can be said that the sufficient number of corresponding feature points for estimating the position and posture of the imaging device that has captured the target image has not been specified. Therefore, the number of corresponding feature points is smaller than the predetermined number of corresponding feature points, the specification unit 12 increases the number of corresponding feature points to be used for estimating the position and posture of the imaging device that has captured the target image by increasing the number of new feature points to be detected from the target image. As a result, the estimation unit 13 can improve estimation accuracy for the position and posture of the imaging device related to the target image.

Alternatively, in a case where the number of corresponding feature points used to estimate the position and posture of the imaging device in a plurality of target images including the first image tends to increase, the detection unit 11 may reduce the number of new feature points to be detected from the target image to a number smaller than the currently set number. Furthermore, in a case where the number of corresponding feature points used to estimate the position and posture of the imaging device in the plurality of target images including the first image tends to decrease, the detection unit 11 may increase the number of new feature points to be detected from the target image to a number larger than the currently set number.

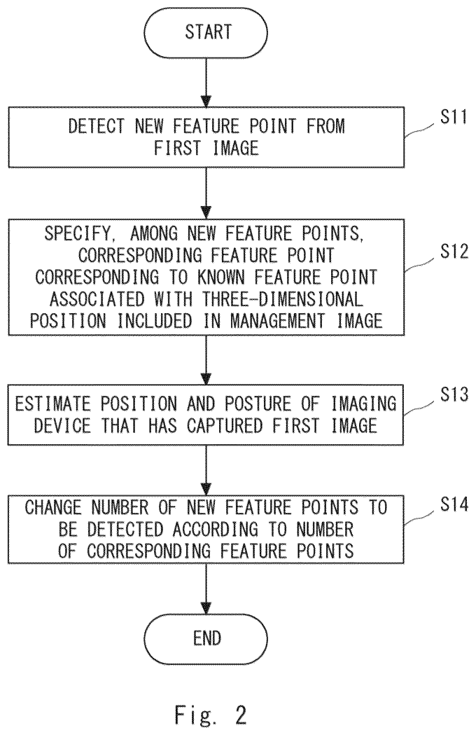

Next, a flow of self-position estimation processing executed in the information processing apparatus 10 according to the first example embodiment will be described with reference to FIG. 2. The self-position estimation is processing of estimating the position and posture of the imaging device that has captured the target screen.

First, the detection unit 11 detects the plurality of new feature points from the first image (S11). Next, the specification unit 12 specifies, among the plurality of new feature points, the corresponding feature point corresponding to the known feature point associated with the three-dimensional position included in at least one management image used for generating the environment map (S12).

Next, the estimation unit 13 estimates the position and posture of the imaging device that has captured the first image, by using the corresponding feature point (S13). Next, the detection unit 11 changes the number of new feature points to be detected from the target image that is the target for estimating the position and posture of the imaging device according to the number of corresponding feature points (S14).

As described above, the information processing apparatus 10 according to the first example embodiment changes the number of new feature points to be detected from the target image that is the target for estimating the position and posture of the imaging apparatus according to the number of corresponding feature points. As a result, the information processing apparatus 10 can maintain the estimation accuracy for the position and posture of the imaging apparatus that has captured the target image, and can reduce the processing load.

### Second Example Embodiment

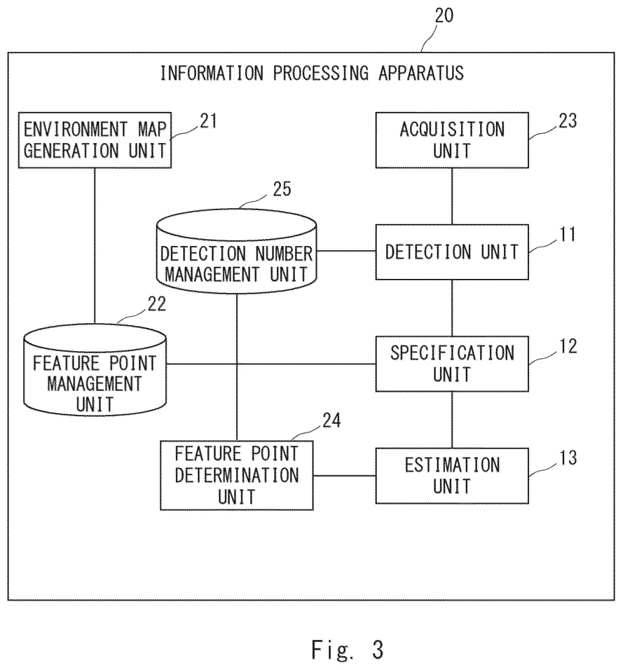

Next, a configuration example of an information processing apparatus 20 according to a second example embodiment will be described with reference to FIG. 3. The information processing apparatus 20 may be a computer apparatus similarly to the information processing apparatus 10. The information processing apparatus 20 has a configuration in which an environment map generation unit 21, a feature point management unit 22, an acquisition unit 23, a feature point determination unit 24, and a detection number management unit 25 are added to the configuration of the information processing apparatus 10. In the following description, a detailed description of configurations and functions similar to those of the information processing apparatus 10 in FIG. 1 will be omitted.

The environment map generation unit 21, the feature point management unit 22, the acquisition unit 23, the feature point determination unit 24, and the detection number management unit 25 may be software components or modules whose processing is carried out by causing a processor to execute a program stored in a memory. Alternatively, the environment map generation unit 21, the feature point management unit 22, the acquisition unit 23, the feature point determination unit 24, and the detection number management unit 25 may be hardware such as a circuit or a chip. Alternatively, the feature point management unit 22 and the detection number management unit 25 may be memories that store data.

The information processing apparatus 20 estimates a position and posture of an imaging device that has captured each image in real time by using a plurality of images captured by the imaging device. For example, the information processing apparatus 20 executes VSLAM to estimate in real time the position and posture of the imaging device that has captured each image. The information processing apparatus 20 may be used to correct a position and posture of an autonomously moving robot. In the estimation of the position and posture of the autonomously moving robot, an image captured in real time by the moving robot is compared with an environment image similar to an image captured in real time among management images in an environment map. The environment image corresponds to the management image. The comparison between the image captured in real time and the environment image is performed using a feature point included in each image. The position and posture of the robot are estimated and corrected based on the comparison result. Here, estimation and correction of the position and posture of the robot are performed by the VSLAM. Furthermore, in the present disclosure, the robot is not limited to an apparatus form as long as the robot can move, and examples of the robot widely include a robot in a form imitating human or an animal and a transport vehicle (for example, an automated guided vehicle) in a form moving using wheels. The transport vehicle may be, for example, a forklift.

The environment map generation unit 21 may generate the environment map by executing SfM using the plurality of images captured by the imaging device. In a case where the information processing apparatus 20 has a camera function, the environment map generation unit 21 may generate the environment map by using an image captured by the information processing apparatus 20. Alternatively, the environment map generation unit 21 may receive an image captured by an imaging device that is a device separate from the information processing apparatus 20 via a network or the like to generate the environment map.

The environment map generation unit 21 outputs the environment map and the plurality of images used for generating the environment map to the feature point management unit 22. At this time, the environment map generation unit 21 may output only information regarding the feature point detected in the image to the feature point management unit 22 without directly outputting image information to the feature point management unit 22. The feature point management unit 22 manages the environment map and the images received from the environment map generation unit 21. Alternatively, the feature point management unit 22 manages the information regarding the feature point received from the environment map generation unit 21. In addition, the feature point management unit 22 manages each image received from the environment map generation unit 21 in association with the position and posture of the imaging device that has captured each image. Further, the feature point management unit 22 manages each image and three-dimensional coordinates of the feature point in each image on the environment map in association with each other. The image managed by the feature point management unit 22 may be referred to as a key frame. Here, the key frame can also be said to be a frame image that can serve as a base point for a series of image processing described below. Further, the three-dimensional coordinates of the feature point in the key frame on the environment map may be referred to as a landmark.

The acquisition unit 23 acquires the image captured by the imaging device or a plurality of frame images constituting a moving image. The acquisition unit 23 acquires the image captured by the imaging device mounted on the autonomously moving robot in substantially real time. That is, the acquisition unit 23 acquires the image or the like captured by the imaging device in real time in order to estimate the position and posture of the autonomously moving robot or the imaging device in real time. In the following description, the image acquired by the acquisition unit 23 will be referred to as a real-time image.

A detection unit 11 detects a feature point in the real-time image according to the target number of feature points to be detected. The detection unit 11 detects a number of feature points in the real-time image that approaches the target number. Specifically, the detection unit 11 may detect the same number of feature points as the target number, or may detect a number of feature points within a predetermined range including the target number. That is, the detection unit 11 may detect a larger number of feature points than the target number, or may detect a smaller number of feature points than the target number. A difference between the number of feature points detected by the detection unit 11 and the target number needs to be a value sufficiently smaller than the target number. That is, the difference between the number of feature points detected by the detection unit 11 and the target number needs to be a number that can be recognized as an error for the target number. The target number may be changed for each real-time image that is a target for detecting the feature point. Alternatively, the target number may be changed for each of a plurality of real-time images that are targets for detecting the feature point. That is, the same target number may be applied to the plurality of real-time images.

The specification unit 12 specifies a new feature point matching a feature point (known feature point) managed by the feature point management unit 22 from among a plurality of feature points (new feature points) extracted from the real-time image. Specifically, the specification unit 12 compares a feature vector of the known feature point with a feature vector of the new feature point, and matches feature points having vectors indicating close distances. The specification unit 12 may extract some images from the plurality of images managed by the feature point management unit 22 and specify the new feature point matching the known feature point included in each image.

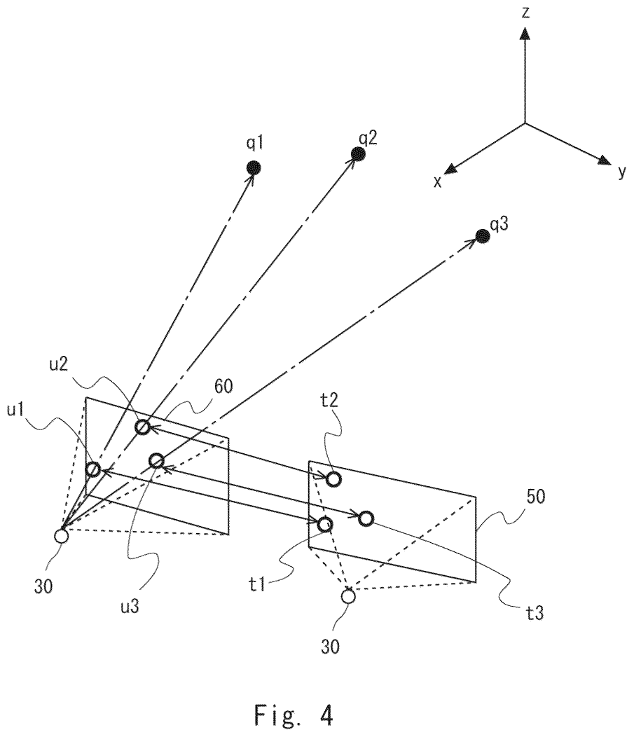

Here, feature point matching processing executed by the specification unit 12 will be described with reference to FIG. 4. FIG. 4 illustrates the feature point matching processing using a key frame 60 and a real-time image 50. u1, u2, and u3 in the key frame 60 are known feature points, and t1, t2, and t3 in the real-time image 50 are new feature points detected by the detection unit 11. The specification unit 12 specifies t1, t2, and t3 as new feature points matching u1, u2, and u3, respectively. That is, t1, t2, and t3 are corresponding feature points corresponding to u1, u2, and u3, respectively.

Further, q1 is three-dimensional coordinates associated with the known feature point u1, and represents a landmark of the known feature point u1. q2 represents a landmark of the known feature point u2, and q3 represents a landmark of the known feature point u3.

Since the new feature point t1 matches the known feature point u1, the three-dimensional coordinates of the new feature point t1 are the landmark q1. Similarly, three-dimensional coordinates of the new feature point t2 are the landmark q2, and three-dimensional coordinates of the new feature point t3 are the landmark q3.

The estimation unit 13 estimates the position and posture of the imaging device that has captured the real-time image 50 by using the known feature points u1, u2, and u3, the new feature points t1, t2, and t3, and the landmarks q1, q2, and q3. Specifically, the estimation unit 13 first assumes a position and posture of an imaging device 30 that has captured the real-time image 50. The feature point detection unit 23 projects, on the real-time image 50, positions of q1, q2, and q3 in a case where q1, q2, and q3 are imaged at the assumed position and posture of the imaging device 30. The estimation unit 13 repeats changing the position and posture of the imaging device 30 that has captured the real-time image 50 and projecting, on the real-time image 50, the positions of q1, q2, and q3. The estimation unit 13 estimates, as the position and posture of the imaging device 30, a position and posture of the imaging device 30 at which differences between the positions of q1, q2, and q3 projected on the real-time image 50 and t1, t2, and t3, which are the feature points in the real-time image 50, are the smallest.

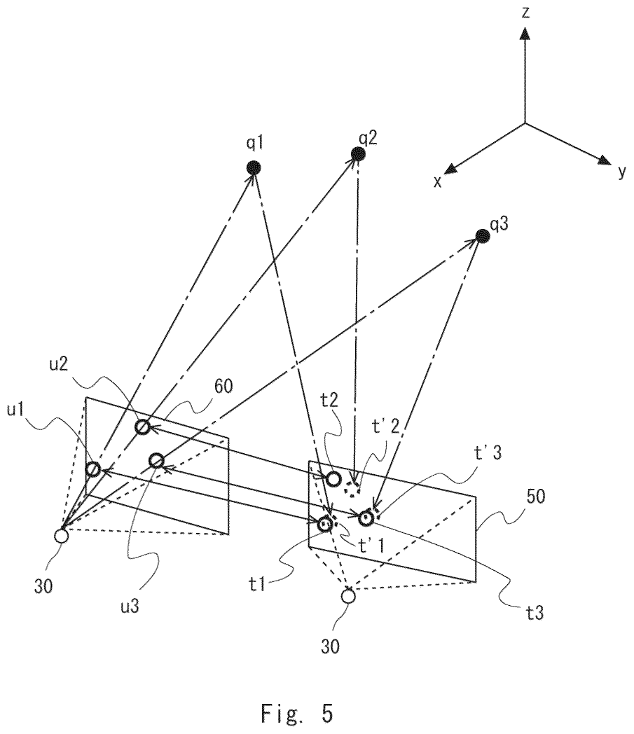

Here, feature point classification processing executed by the feature point determination unit 24 will be described with reference to FIG. 5. In a case where the position and posture of the imaging device 30 that has captured the real-time image 50 are the position and posture estimated by the estimation unit 13, the feature point determination unit 24 determines t′1, t′2, and t′3 as the positions of q1, q2, and q3 projected on the real-time image 50. That is, t′1, t′2, and t′3 are the positions of q1, q2, and q3 in the real-time image 50 when the imaging device 30 has captured the real-time image 50 at the position and posture estimated by the estimation unit 13. Dotted circles in the real-time image 50 of FIG. 5 indicate t′1, t′2, and t′3.

Here, the feature point determination unit 24 obtains a distance between t1 and t′1 associated with the landmark q1, a distance between t2 and t′2 associated with the landmark q2, and a distance between t3 and t′3 associated with the landmark q1. In FIGS. 5, t′1 and t′3 represents substantially the same positions as t1 and t3, or distances between t′1 and t′3 and t1 and t3 are equal to or shorter than a predetermined distance. In addition, FIG. 5 illustrates that the position of t′2 is different from t2 and is separated from t2 by a predetermined distance or more.

The fact that the position of t′2 is different from t2 indicates that t2 is shifted from the position of the landmark q2 to be displayed on the real-time image 50. That is, matching accuracy for the new feature point t2 with respect to the known feature point u2 is low. On the other hand, the fact that the positions of t′1 and t′3 are substantially the same as t1 and t3 indicates that the landmarks q1 and q3 to be displayed on the real-time image 50 match t1 and t3. That is, matching accuracy for the new feature points t1 and t3 with respect to the known feature points u1 and u3 is high. In the feature point determination unit 24, t2 in FIG. 5 is referred to as a low-accuracy feature point, and t1 and t3 are referred to as high-accuracy feature points. That is, the feature point determination unit 24 classifies t2 in FIG. 5 as the low-accuracy feature point, and classifies t1 and t3 as the high-accuracy feature points. The high-accuracy feature point may be referred to as an inlier feature point, and the low-accuracy feature point may be referred to as an outlier feature point.

The feature point determination unit 24 outputs, to the detection number management unit 25, the number of high-accuracy feature points and the number of low-accuracy feature points among the new feature points used to estimate the position and posture of the imaging device 30 in the real-time image 50. Alternatively, the feature point determination unit 24 may output only the number of high-accuracy feature points to the detection number management unit 25.

The detection number management unit 25 calculates a target number of feature points to be detected from the real-time image acquired by the acquisition unit 23 by using the number of high-accuracy feature points received from the feature point determination unit 24. The target number fₙ of feature points to be detected from the n-th real-time image acquired by the acquisition unit 23 may be calculated using, for example, the following Equation 1.

$${f}_{n} = {f}_{n - 1} + α \times ( I - {i}_{n - i} ) \qquad ( Equation 1 )$$

“I” indicates a target number of high-accuracy feature points, and iₙ₋ᵢ indicates the number of high-accuracy feature points in the previous frame (previous image). In addition, a represents a coefficient and is a number larger than 0. α may have the same value in both of a case where I−iₙ₋ᵢ≥0 and a case where I−iₙ₋ᵢ<0, and may have a different value between a case where I−iₙ₋ᵢ≥0 and a case where I−iₙ₋ᵢ<0.

For example, α=2 in a case where I−iₙ₋ᵢ≥0, and α=1 in a case where I−iₙ₋ᵢ<0. A case where I−iₙ₋ᵢ≥0 is a case where the number of specified high-accuracy feature points does not reach the target number of high-accuracy feature points, and a case where I−iₙ₋ᵢ<0 is a case where the number of specified high-accuracy feature points exceeds the target number of high-accuracy feature points. Increasing a value of a in a case where I−iₙ₋ᵢ≥0 to be larger than a value of α in a case where I−iₙ₋ᵢ<0 means increasing the target number of feature points when the number of specified high-accuracy feature points does not reach the target number of high-accuracy feature points. In addition, increasing the value of α in a case where I−iₙ₋ᵢ≥0 to be larger than the value of α in a case where I−iₙ₋ᵢ<0 means reducing the target number of feature points when the number of specified high-accuracy feature points exceeds the target number of high-accuracy feature points. That is, it means that emphasis is placed on improving the estimation accuracy for the position and posture of the imaging device rather than reducing the processing load of the processing of estimating the position and posture of the imaging device.

On the other hand, the value of α in a case where I−iₙ₋ᵢ≥0 may be smaller than the value of α in a case where I−iₙ₋ᵢ<0. This means that emphasis is placed on reducing the load of the processing of estimating the position and posture of the imaging device rather than improving the estimation accuracy in the processing of estimating the position and posture of the imaging device.

Furthermore, the coefficient α may be determined using a function g(iₙ) that obtains a correlation function between the target number fₙ of feature points and the number iₙ of high-accuracy feature points and has the number iₙ of high-accuracy feature points as a variable. Alternatively, the coefficient α may be determined using a function that holds a result of estimating a position and posture of an image for a certain period and has a change amount of the position and posture between the latest real-time images as a variable. The change amount is, for example, a speed, and the function having the change amount as a variable may be a function having the speed as a variable.

In addition, in a case where the target number of feature points is excessively large, the load of the processing of estimating the position and posture of the imaging device increases, and in a case where the target number of feature points is excessively small, the estimation accuracy for the position and posture of the imaging device deteriorates. Therefore, a maximum value and a minimum value may be determined for the target number of feature points, and a value between the minimum value and the maximum value may be used as the target number of feature points.

An arbitrary value may be determined as the number of target high-accuracy feature points by an administrator or the like of the information processing apparatus 20. For example, a value considered to be appropriate by the administrator or the like of the information processing apparatus 20 may be determined as the target number of feature points. Alternatively, the target number of high-accuracy feature points may be determined using machine learning. For example, the target number of high-accuracy feature points may be determined using a learning model that learns a relation between the number of high-accuracy feature points and the processing load of the information processing apparatus 20 or the estimation accuracy for the position and posture.

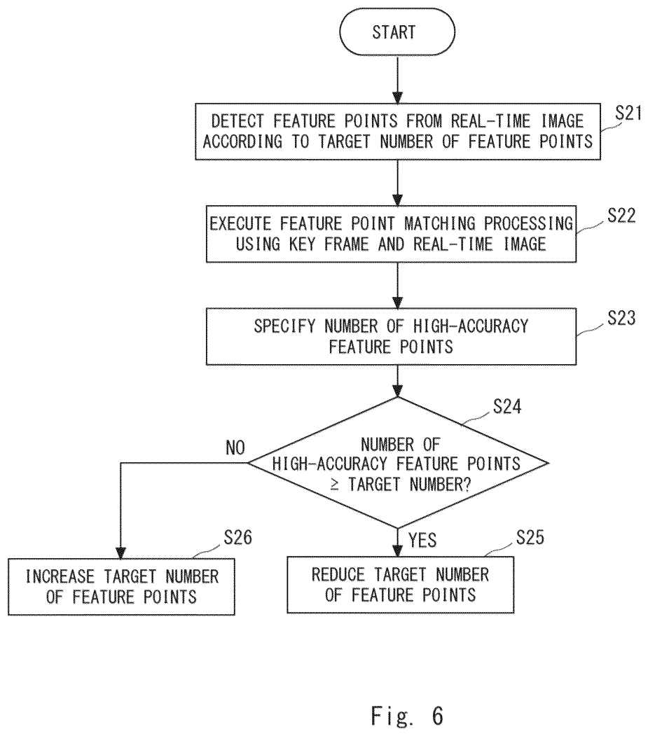

Next, a flow of processing of updating the target number of feature points according to the second example embodiment will be described with reference to FIG. 6. First, the detection unit 11 detects the feature points from the real-time image acquired by the acquisition unit 23 according to the target number of feature points (S21). Next, the specification unit 12 specifies the new feature points matching the known feature points managed by the feature point management unit 22 from among the new feature points extracted from the real-time image (S22).

Next, the feature point determination unit 24 classifies the new feature points matching the known feature points managed by the feature point management unit 22 into the high-accuracy feature point and the low-accuracy feature point, and specifies the number of high-accuracy feature points (S23).

Next, the detection number management unit 25 determines whether or not the number of high-accuracy feature points is equal to or larger than the target number of high-accuracy feature points (S24). In a case where it is determined that the number of high-accuracy feature points is equal to or larger than the target number of high-accuracy feature points (YES in S24), the detection number management unit 25 updates the target number of feature points so as to reduce the target number of feature points (S25). In a case where it is determined that the number of high-accuracy feature points is smaller than the target number of high-accuracy feature points (NO in S24), the detection number management unit 25 updates the target number of feature points so as to increase the target number of feature points (S26).

As described above, the information processing apparatus 20 according to the second example embodiment specifies the new feature point that is included in the real-time image and matches the known feature point. Furthermore, the information processing apparatus 20 specifies the high-accuracy feature point whose distance from a projection point obtained by projecting the three-dimensional position of the known feature point on the real-time image is shorter than a predetermined distance among the new feature points matching the known feature points. Furthermore, the detection number management unit 25 determines the target number of feature points to be extracted from the real-time image according to the number of high-accuracy feature points.

In general, as the number of high-accuracy feature points used for estimation of the position and posture of the imaging device increases, the estimation accuracy for the position and posture is improved. It is assumed that a certain number of high-accuracy feature points are included in the new feature points extracted from the real-time image. In this case, as the number of high-accuracy feature points increases, the number of new feature points to be extracted from the real-time image also increases. Therefore, the number of feature points used for the estimation accuracy for the position and posture also increases, and thus, the processing load of the information processing apparatus 20 also increases. Therefore, in a case where the number of high-accuracy feature points is equal to or larger than the target number of high-accuracy feature points, it is considered that a sufficiently high estimation accuracy for the position and posture can be maintained, and thus, the target number of feature points to be extracted from the real-time image can be reduced. As a result, it is possible to prevent an increase in processing load for the position and the posture while maintaining the estimation accuracy for the position and the posture.

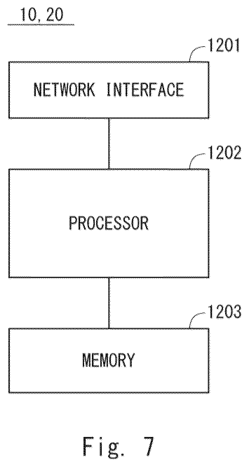

FIG. 7 is a block diagram illustrating a configuration example of the information processing apparatus 10 and the information processing apparatus 20 (hereinafter, referred to as the information processing apparatus 10 and the like) described in the above-described example embodiments. Referring to FIG. 7, the information processing apparatus 10 and the like include a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 reads and executes software (computer program) from the memory 1203 to perform processing of the information processing apparatus 10 and the like described with reference to the flowcharts in the above-described example embodiments. The processor 1202 may be, for example, a microprocessor, a micro processing unit (MPU), or a central processing unit (CPU). The processor 1202 may include a plurality of processors.

The memory 1203 is configured in a combination of a volatile memory and a nonvolatile memory. The memory 1203 may include a storage disposed away from the processor 1202. In this case, the processor 1202 may access the memory 1203 through an input/output (I/O) interface (not shown).

In the example in FIG. 7, the memory 1203 is used to store a group of software modules. The processor 1202 can perform a process of the information processing apparatus 10 and the like described in the above-described example embodiments by reading and executing these software module groups from the memory 1203.

As described with reference to FIG. 7, each of the processors included in the information processing apparatus 10 and the like in the above-described example embodiments executes one or more programs including a command group for causing a computer to perform the algorithm described with reference to the drawings.

In the above-described example, the program includes a group of instructions (or software code) for causing a computer to perform one or more functions described in the example embodiments when the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, the transitory computer-readable medium or the communication medium includes an electrical signal, an optical signal, an acoustic signal, or any other form of propagated signal.

Note that the technical ideas of the present disclosure are not limited to the above-described example embodiments, and can be appropriately modified without departing from the scope.

### REFERENCE SIGNS LIST

10 INFORMATION PROCESSING APPARATUS
11 DETECTION UNIT
12 SPECIFICATION UNIT
13 ESTIMATION UNIT
20 INFORMATION PROCESSING APPARATUS
21 ENVIRONMENT MAP GENERATION UNIT
22 FEATURE POINT MANAGEMENT UNIT
23 ACQUISITION UNIT
24 FEATURE POINT DETERMINATION UNIT
25 DETECTION NUMBER MANAGEMENT UNIT
30 IMAGING DEVICE
50 REAL-TIME IMAGE
60 KEY FRAME

What is claimed is:

1. An information processing apparatus comprising:
at least one memory storing instructions; and
at least one processor configured to execute the instructions to:
detect a plurality of new feature points from a first image;
specify, among the plurality of new feature points, a corresponding feature point corresponding to a known feature point associated with a three-dimensional position included in at least one management image used for generating an environment map;
estimate a position and a posture of an imaging device that has captured the first image, by using the corresponding feature point; and
change the number of new feature points to be detected from a target image that is a target for estimating the position and the posture of the imaging device, according to the number of corresponding feature points.

2. The information processing apparatus according to claim 1, wherein the at least one processor is further configured to execute the instructions to: reduce the number of new feature points to be detected from the target image to a number smaller than a currently set number in a case where the number of corresponding feature points is larger than a target number, and increase the number of new feature points to be detected from the target image to a number larger than the currently set number in a case where the number of corresponding feature points is smaller than the target number.

3. The information processing apparatus according to claim 1, wherein the at least one processor is further configured to execute the instructions to:
specify a high-accuracy feature point of which a distance between a projection point obtained by projecting, on the first image, the three-dimensional position associated with the known feature point and the corresponding feature point is shorter than a predetermined distance, and a low-accuracy feature point of which the distance between the projection point and the corresponding feature point is longer than the predetermined distance, and
change the number of new feature points to be detected from the target image that is the target for estimating the position and the posture of the imaging device, according to the number of high-accuracy feature points.

4. The information processing apparatus according to claim 3, wherein the at least one processor is further configured to execute the instructions to: reduce the number of new feature points to be detected from the target image to a number smaller than a currently set number in a case where the number of high-accuracy feature points is larger than a target number of high-accuracy feature points, and increase the number of new feature points to be detected from the target image to a number larger than the currently set number in a case where the number of high-accuracy feature points is smaller than the target number of high-accuracy feature points.

5. The information processing apparatus according to claim 4, wherein the at least one processor is further configured to execute the instructions to: subtract, from a currently set number of new feature points to be detected, a value obtained by subtracting the target number of high-accuracy feature points from the number of high-accuracy feature points in a case where the number of high-accuracy feature points is larger than the target number of high-accuracy feature points, and add, to the currently set number of new feature points to be detected, a value obtained by subtracting the number of high-accuracy feature points from the target number of high-accuracy feature points in a case where the number of high-accuracy feature points is smaller than the target number of high-accuracy feature points.

6. The information processing apparatus according to claim 5, wherein the at least one processor is further configured to execute the instructions to: subtract, from the currently set number of new feature points to be detected, a value obtained by multiplying the value obtained by subtracting the target number of high-accuracy feature points from the number of high-accuracy feature points by a first coefficient in a case where the number of high-accuracy feature points is larger than the target number of high-accuracy feature points, and add, to the currently set number of new feature points to be detected, a value obtained by multiplying the value obtained by subtracting the number of high-accuracy feature points from the target number of high-accuracy feature points by a second coefficient in a case where the number of high-accuracy feature points is smaller than the target number of high-accuracy feature points, the first coefficient and the second coefficient being positive numbers, and the first coefficient being a value smaller than the second coefficient.

7. The information processing apparatus according to claim 1, wherein the at least one processor is further configured to execute the instructions to change the number of new feature points to be detected from the target image in a range between a maximum value and a minimum value of the number of new feature points to be detected from the target image.

8. A self-position estimation method comprising:
detecting a plurality of new feature points from a first image;
specifying, among the plurality of new feature points, a corresponding feature point corresponding to a known feature point associated with a three-dimensional position included in at least one management image used for generating an environment map;
estimating a position and a posture of an imaging device that has captured the first image, by using the corresponding feature point; and
changing the number of new feature points to be detected from a target image that is a target for estimating the position and the posture of the imaging device according to the number of corresponding feature points.

9. A non-transitory computer-readable medium storing a program for causing a computer to execute:
detecting a plurality of new feature points from a first image;
specifying, among the plurality of new feature points, a corresponding feature point corresponding to a known feature point associated with a three-dimensional position included in at least one management image used for generating an environment map;
estimating a position and a posture of an imaging device that has captured the first image, by using the corresponding feature point; and
changing the number of new feature points to be detected from a target image that is a target for estimating the position and the posture of the imaging device according to the number of corresponding feature points.
